(19) United States
(12) Patent Application Publication
(10) Pub. No.: US 2005/0177442 A1
(43) Pub. Date: Aug. 11, 2005

(54) Method and system for performing a retail transaction using a wireless device

(76) Inventors: James B. Sullivan, Dublin, OH (US); Kevin Jennings, Columbus, OH (US); Doug Hall, Newtown, OH (US); Jeffrey Stamp, Cincinnati, OH (US)

Correspondence Address: AKIN, GUMP, STRAUSS, HAUER & FELD, 1111 LOUISIANA STREET, 44TH FLOOR, HOUSTON, TX, 77002, US

(21) Appl. No.: 10/754,427

(22) Filed: Jan. 9, 2004

(51) Int. Cl. G06F 17/60

(52) U.S. Cl. 705/26

(57) ABSTRACT

A method and system for performing retail transactions allows use of a wireless device in lieu of conventional financial cards. A retail system sends customer-independent transaction data, which is matched with a customer account associated with a wireless device. A customer sends a wireless communication from a wireless device to a server. The server identifies the wireless device and identifies a customer account associated with the wireless device. The customer account and the customer-independent transaction data are matched together, authorizing the retail transaction. When multiple retail transactions occur within a short time, a matching technique scores matches between multiple retail transactions and multiple customer-initiated wireless communications.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

1. Field of the Invention

The present invention relates to the field of processing retail transactions, and in particular to a technique for using a wireless device for performing a retail transaction in lieu of a conventional financial card.

2. Description of the Related Art

Consumers use conventional plastic credit and debit cards for millions of retail transactions annually. In addition to bank cards such as Visa® and MasterCard®, which are widely available and useable at large numbers of unrelated retail entities, numerous entities provide “private-label” cards, which are typically only useable at a single retailer or chain of retailers. Traditionally, these private-label cards have been associated with department stores, specialty stores, gasoline companies, and other such retailers although the actual issuer and credit provider may be a third party credit provider that provides private label services for multiple retail chains. Some consumers have found private label cards less convenient than widely accepted bank cards because of the limited acceptance of these cards at only retail locations associated in some way with the issuing retailer, which requires consumers to carry multiple private label cards, one for each retailer. Some retailers have provided special-purpose devices, such as the radio frequency identification device (RFID) SPEEDPASS® key fob from ExxonMobil Corporation, to use instead of conventional cards. However, these RFID and other special-purpose devices are also limited acceptance devices; thus, a consumer may need to carry multiple special-purpose devices for multiple retailers.

Other techniques have used wireless phones, either by having the customer dial a special phone number and then enter a personal code value to authorize or perform the transaction or by embedding a special chip in the wireless phone to act as a kind of smart card reader, transmitting customer account information in a wireless call. However, these techniques have proven cumbersome or require modifications to customer or retailer equipment, limiting their usefulness.

### BRIEF SUMMARY OF THE INVENTION

In brief, a technique for performing a retail transaction matches a retail transaction with a wireless communication. A retail system communicates a retail transaction data to a transaction server. The customer initiates a wireless communication from a wireless communication device to the transaction server. The transaction server matches the wireless communication with the retail transaction data. The transaction server then authorizes the retail transaction. In one embodiment, the retail transaction data includes data from a customer independent token, which can supply customer independent account data. The retail transaction data may be otherwise identical to conventional standardized retail transaction data.

In one disclosed embodiment, matching the retail transaction data with the wireless communication comprises identifying the sender of a customer-initiated wireless communication, linking a customer account to data associated with the sender, and matching the retail transaction data to the wireless communication. If an error is detected in the matching process, a rematching process may be initiated.

### BRIEF DESCRIPTION OF THE SEVERAL VIEWS OF THE DRAWINGS

A better understanding of the present invention can be obtained when the following detailed description of various disclosed embodiments is considered in conjunction with the following drawings, in which:

FIG. 1 is a flowchart illustrating a conventional prior art financial card transaction process;

FIG. 2 is a block diagram of a system for processing transactions using a wireless device.

FIG. 3 is a flowchart illustrating an overview of a retail transaction according to a disclosed embodiment;

FIG. 4 is a flowchart illustrating receipt of a transaction according to a disclosed embodiment;

FIG. 5 is a flowchart illustrating receipt of a wireless call according to a disclosed embodiment;

FIG. 6 is a flowchart illustrating an embodiment of a matching technique; and

FIG. 7 is a flowchart illustrating an embodiment of a rematching technique.

### DETAILED DESCRIPTION OF THE INVENTION

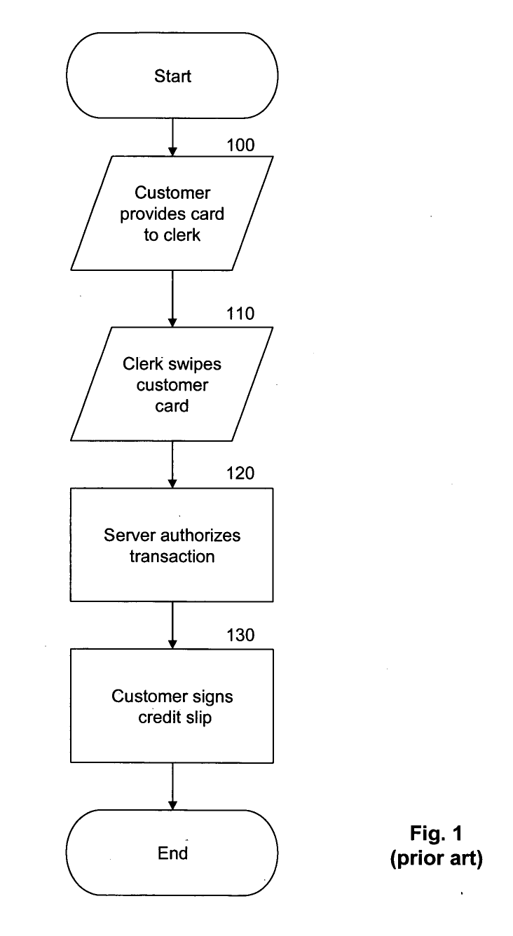

The basic process for a conventional financial card transaction is well known. As illustrated in the simplified prior art flowchart of FIG. 1, after selecting items for a retail transaction, in block 100 a customer typically provides a retail clerk with a financial card issued to the customer. As used herein, the term “financial card” should be understood to include credit, debit, stored value, and all other types of financial cards, without distinction, regardless of issuer. Many issuers and types of financial cards are known. Although financial cards are typically roughly rectangular plastic cards of a standardized size, with magnetic stripes on a reverse side of the card, other kinds and shapes of cards are known, and should be considered financial cards for the purposes of this application.

The retail clerk then, in block 110, typically swipes the financial card through a card reader, which reads the financial card and extracts customer account information from the card. Other techniques for reading the financial card are known. The customer account information and the retail transaction data are then sent to an authorization server, which authorizes or declines the transaction to the retailer in block 120. The retailer typically produces or prints a charge or sales slip, which the customer signs in block 130 to complete the transaction. Retailers commonly use Point Of Sale (POS) terminals for sending authorization requests and transaction data to the server, although other retail sales terminals or registers, including dedicated credit terminals, may be used. As used herein, a POS system includes conventional POS systems as well as other retail sales terminals or registers. In some establishments, the customer, instead of the clerk, may swipe the card. The customer may not need to sign a charge slip for some forms of transactions or with certain types of financial cards. Debit financial cards typically do not require a signature. In many situations, the customer cannot complete the transaction without having the physical card present.

As noted above, private-label financial card issuers have learned that some customers find private-label financial cards less convenient, because the customer must carry separate cards for each private-label card-accepting retailer. Although some devices have been proposed for multiple-identity financial cards, such as in U.S. Pat. No. 5,530,232, issued to Taylor, such cards have not been widely used.

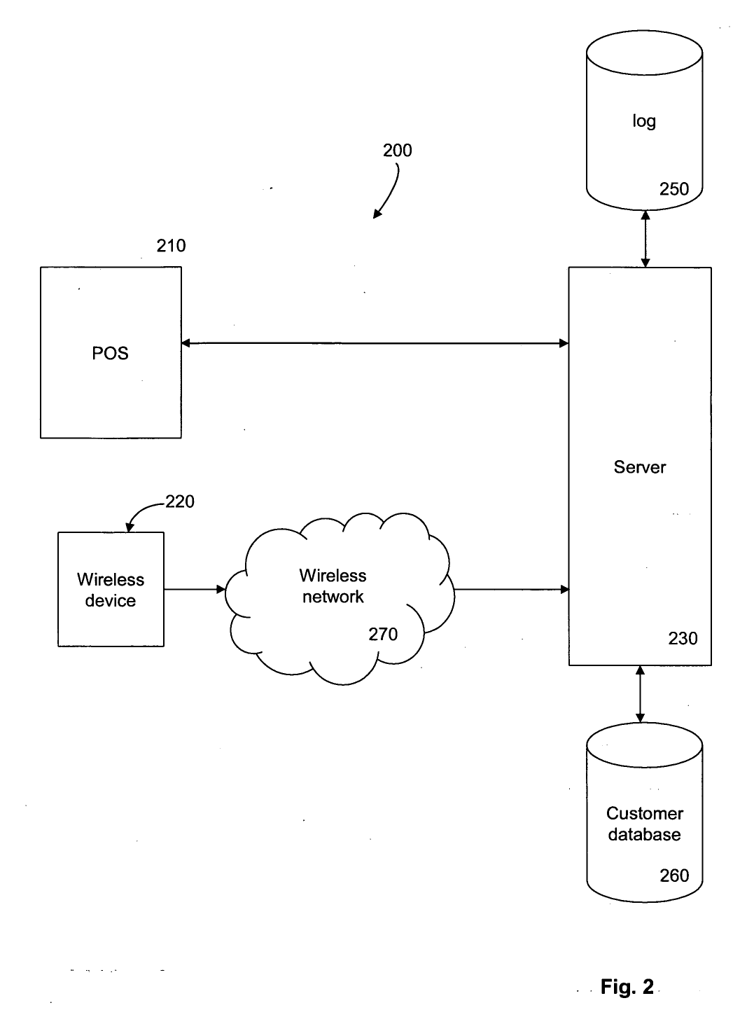

Turning now to FIG. 2, a block diagram illustrates a system 200 for performing a retail transaction according to one embodiment that may eliminate the need for the physical financial card all together, much less for the customer to carry the physical card. As shown in FIG. 2, a POS system 210 sends retail transaction data to a transaction server 230. The POS system 210 may, depending on the establishment, be one of a plurality of POS terminals connected to a POS store system, or any convenient apparatus for accepting a financial card for payment of a transaction and requesting authorization of the transaction. In one embodiment, the POS 210 is an unmodified POS system that can be used for conventional prior art transactions, as described above. In other embodiments, the POS system 210 may be modified as described below for wireless-enabled transactions, while remaining capable of performing conventional prior art transactions.

A retail clerk, upon a customer identifying a retail transaction as a wireless-enabled transaction, may send retail transaction data from the POS system 210 using the conventional retail transaction process, substituting a customer-independent token, such as a retailer financial card or dummy financial card for the customer financial card. The retailer or dummy financial card may provide a special dummy account number in the retail transaction data, which can be recognized by the server 230. Meanwhile, the customer initiates a wireless communication to the server 230, using a customer-controlled wireless device 220. Although preferably the customer makes the wireless communication prior to the retail clerk sending the retail transaction data to the server 230, these actions may be performed in any order or simultaneously. The wireless device 220 typically will be a wireless phone connected to a conventional wireless carrier. However, any other form of wireless communications device allowing customer-controlled and initiated communications or calls may be used, such as a Personal Digital Assistant (PDA), some of which have wireless communication capabilities. As used herein, the term wireless phone should be considered to include such other forms of wireless communications devices. The wireless communication will typically be made through a wireless network 270 of a wireless carrier, such as one of the many wireless telephone carriers. However, other forms of transporting the wireless communication may be used instead of or in conjunction with the wireless network 270.

As part of the completion of the wireless communication, the server 230 will receive the communication, typically acknowledging the communication to the customer in some manner, not significant to this invention. In some embodiments, the server 230 may include an interactive voice response (IVR) system that may confirm to the customer that the communication has successfully reached the proper server 230. In some embodiments, the customer may provide a security code, such as a Personal Identification Number (PIN) to confirm that the wireless communication is being made by an authorized user of the wireless device, authenticating the wireless communication. However, the PIN code is typically not used for matching the wireless communication to the retail transaction. Further, the disclosed technique typically does not depend on any customer controlled data transfer as part of the wireless communication.

The server 230, upon receiving the wireless communication, extracts automatic number identification (ANI) data supplied by the wireless network 270. ANI information identifies a phone number of the calling wireless device. Although as described below in terms of ANI information and a phone number of the calling wireless device, other types of wireless device identification data supplied by the wireless communication can be used in addition to or instead of the ANI data. In some embodiments, the wireless network 270 may supply additional information, such as Global Positioning System (GPS), Automatic Location Identification (ALI), or other similar location data, for providing the location of the wireless device, and whether the wireless device is in its home area or roaming, that may be used to identify or narrow a range of locations for the customer at the time of the wireless communication. Additional information about the wireless communication may be obtained for matching purposes such as the location of a wireless network 270 to credit provider access point which may be separate from the server 230.

The server 230 may then obtain customer account data and customer transaction history data, using the ANI information obtained from the wireless network 270 to look up the customer account data. As shown in FIG. 2, the server 230 uses a customer database 260 for this purpose. Other customer data storage and retrieval techniques may be used. Typically, prior to use of the wireless device for retail transactions, the customer will enroll with the credit provider, providing the phone number of the wireless device to the credit provider for association with a customer account. Although as used herein the wireless device phone number is used for association with the customer account, any other type of wireless device identification data may be used instead of or in addition to a wireless phone number. Upon enrollment by the customer, the phone number of the wireless device may be used as a key for the database 260. Numerous techniques may be used for storing and accessing customer account data and customer transaction history data. Although shown in FIG. 2 as a single customer database, multiple databases may be used for storing and accessing such data.

The server 230 receives the transaction data from the POS system 210. As described in detail below, the server 230 can match the retail transaction with the customer wireless communication. Although shown as a single server 230 in FIG. 2, the capabilities and functionality of server 230 may be provided by a single server or multiple servers which may be co-located or in separate locations and connected in any manner convenient. The server 230, whether implemented as a single server or multiple servers, may be implemented using any convenient computer system or combination of computer systems. In embodiments using a retailer card or dummy card in the POS system 210, the server 230 may modify the transaction by replacing the dummy account number in the transaction data returned to the POS system 210 with the customer account number associated with the wireless device 220. The customer may then sign a charge or sales slip as in a conventional transaction after the server 230 has authorized the transaction back to the POS 210. As with conventional transactions, an authorization data supplied by server 230, typically an authorization code number, may be provided to the POS 210, which the POS 210 may print on the charge slip, as described in detail below.

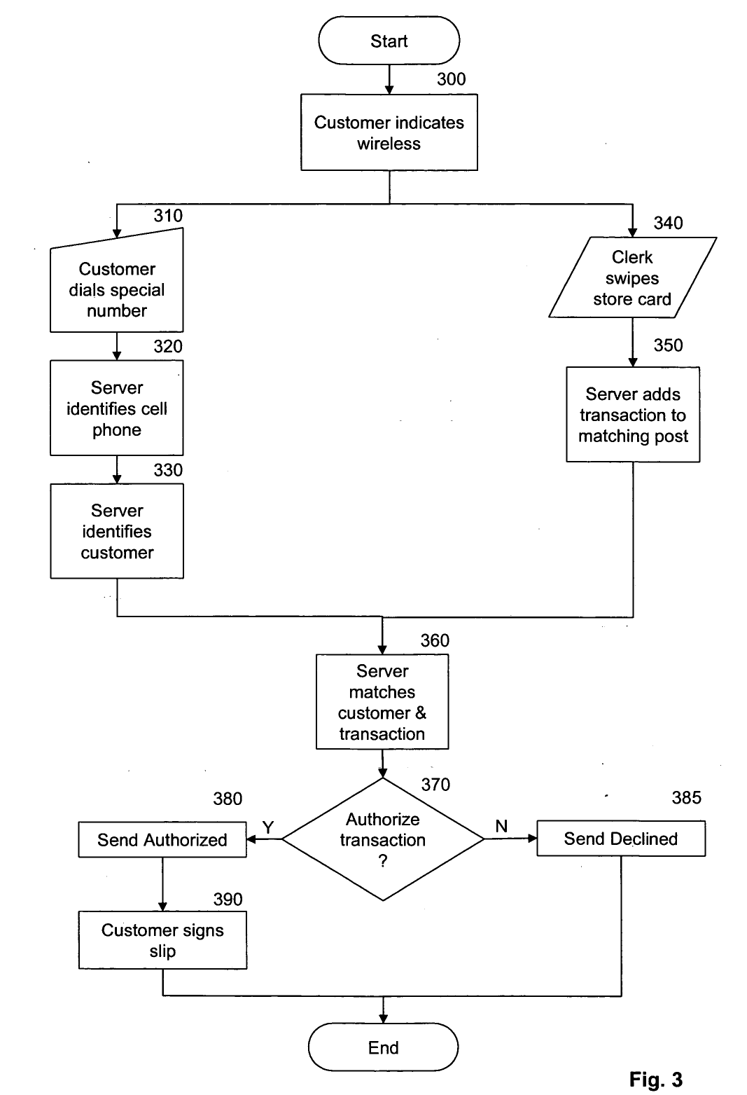

FIGS. 3-7 are flowcharts illustrating various embodiments of a technique for matching retail transactions with wireless communications in a system such as illustrated in FIG. 2. The technique may be implemented in software or hardware or a combination of software and hardware as convenient.

Turning to FIG. 3, a flowchart illustrates a disclosed technique according to one embodiment for using the wireless communication device 220 for retail transactions. In block 300, a customer indicates to a retail clerk that the retail transaction will be a wireless-enabled transaction. This indication to the clerk may be performed by customer in any convenient way. Because the retail system 210 may be used for conventional transactions as well as wireless-enabled transactions, customers desiring a wireless transaction will typically need to tell the clerk which type of transaction to process. In block 310, the customer dials a predetermined special phone number on the customer's wireless device. The special phone number may be dialed as an ordinary 7 or 10-digit phone number, or may be a wireless carrier-provided “star” number, such as *717. Star numbers are typically assigned by a contractual relationship between the credit provider and the wireless carrier, as is well known in the art. The special phone number may be provided to the customer in any convenient way by the retailer at the POS system 210. For example, the clerk may verbally provide the special number to the customer, or the number may be displayed in a visual display near or on the register or elsewhere, or in any other way convenient to the retailer and the customer. Different retailers may use different special phone numbers. Similarly, different registers in a given retailer may use different phone numbers, allowing the server 230 to distinguish the location of the register making the transaction. Mathematical techniques may be used to allocate special phone numbers, including use of the same special phone number in separated areas. The allocation of special phone numbers may be done by the credit provider based on a statistical knowledge of the credit provider on the use of wireless devices, as described in more detail below. Because star numbers are typically wireless carrier-dependent, the credit provider may need to obtain agreements with multiple wireless carriers. The retail display of the star numbers may, therefore, need to indicate multiple numbers, depending on the wireless carriers involved.

Once the customer has dialed the special phone number in block 310, the server 230 receives the call via the wireless network 270 in block 320, then may obtain ANI and other location information regarding the call, as described above. The ANI information may be used by the server 230 to identify the customer in block 330. In one disclosed embodiment, the ANI information may be used as a lookup key in the database 260, obtaining customer name and account number information. In a further embodiment, a customer transaction history may be obtained from the database 260 or any other database available to the server 230 to assist matching.

In block 340, the retail clerk may swipe a special or dummy financial card in lieu of the usual customer financial card. Other techniques for reading the special or dummy financial card may be provided, depending on the POS system 210 or the type of card being used. For example, magnetic stripe financial cards and so-called “smart cards” typically use different techniques for reading information from the card. The special card may be an ordinary financial card with a retailer-dependent or dummy account number encoded on the card in ways known to the art. The retailer-dependent account number is sent in the transaction data sent to server 230 for authorization. In such an embodiment, the POS system 210 may be an unmodified conventional POS system. In another embodiment, a POS system may transmit any other form of special identification to the server 230, such as by the clerk pressing a special “wireless” key on the POS terminal 210, causing the POS terminal 210 to send a modified POS transaction to the server 230 containing a register or retailer identification data without the need for a physical card from either the retailer or the customer. Depending on the retailer and the number POS terminals 210 used at a given location, different POS terminals 210 may be assigned special cards with POS terminal-related dummy account numbers, use the same dummy account number for each POS terminal 210, or a mixture of such cards.

Blocks 310 and 340 may be performed in any order, including simultaneously. However, some embodiments may prefer the wireless communication of block 310 be performed before the retail clerk action of block 340.

In block 350, the server 230 receives the transaction data sent in block 340, placing the transaction data into a matching pool, as described below. Then in step 360, the server 230 matches the transactions in the matching pool against the incoming wireless calls, as described in detail below, matching the customer data to the retail transaction. If block 360 successfully matches a transaction to a call, then in block 370 the server 230 may authorize the transaction, sending a POS transaction authorization back to the POS terminal 210 in a conventional authorization communication in block 380. Although not shown in FIG. 3 for clarity of the flowchart, other conventional authorization actions may be taken by the server 230 based on the credit providers' usual and ordinary techniques for authorizing or declining credit to a given customer.

Alternately, if the server 230 does not match the retail transaction with a wireless communication, or if the credit provider's conventional credit authorization technique declines to authorize a matched transaction, the server 230 may in block 370 decline the transaction, sending a conventional transaction declined communication to the POS terminal 210 in block 385. The customer may then choose to abandon the transaction or retry it, possibly using a different financial card, if available.

In an embodiment in which a special card with a dummy account number is used, the authorization message back to the POS system 210 of block 380 may replace the dummy account with the customer account number for possible printing on the sales slip, which may be a conventional sales slip. Finally, the customer completes the transaction by signing the sales slip in block 390. As in conventional transactions, the retail clerk may request additional identification from the customer as directed by the authorization from the server 250, including signature verification. In one embodiment, a customer may set the customer account to specify how often such additional identification should be requested by the retail clerk.

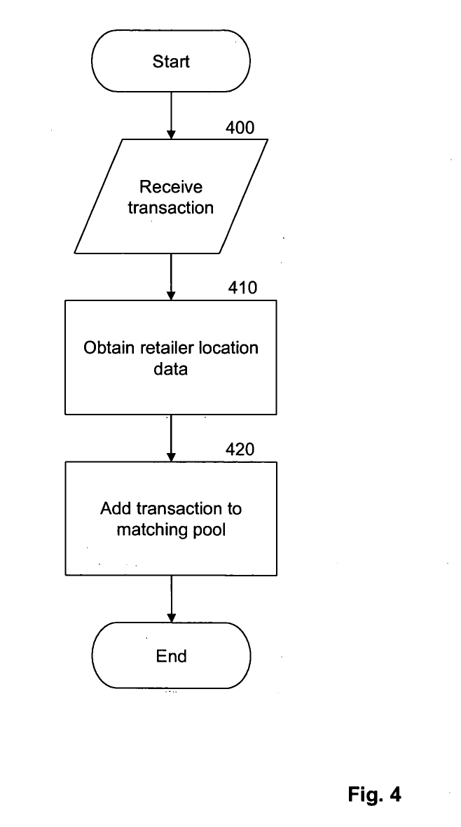

Turning now to FIG. 4, a flowchart illustrates a simplified embodiment of initial handling of a retail transaction by the server 230. In block 400, the server 230 receives a retail transaction from the POS system 210. As described above, the POS 210 may transmit the retail transaction to the server 230 in any convenient way, which may involve one or more intermediaries, including transaction aggregators, such as a central POS system that communicates multiple POS terminals 210 and the server 230.

Then, in block 410, the server 230 analyzes the retail transaction to determine a location of the POS system 210. This may involve decoding or using the dummy account number from the special financial card swiped by the retail clerk in lieu of a customer financial card. Other POS system 210 location data may be obtained as convenient from other sources based on the retail transaction data. The POS system 210 location is associated with the retail transaction data, then in block 420, the server 230 adds the retail transaction to a matching pool of retail transactions for matching with customer wireless communications, as described below.

The POS system 210 location data may be expressed as GPS coordinates or in any other convenient coordinate system or format. Numerous techniques for expressing location data are known to the art.

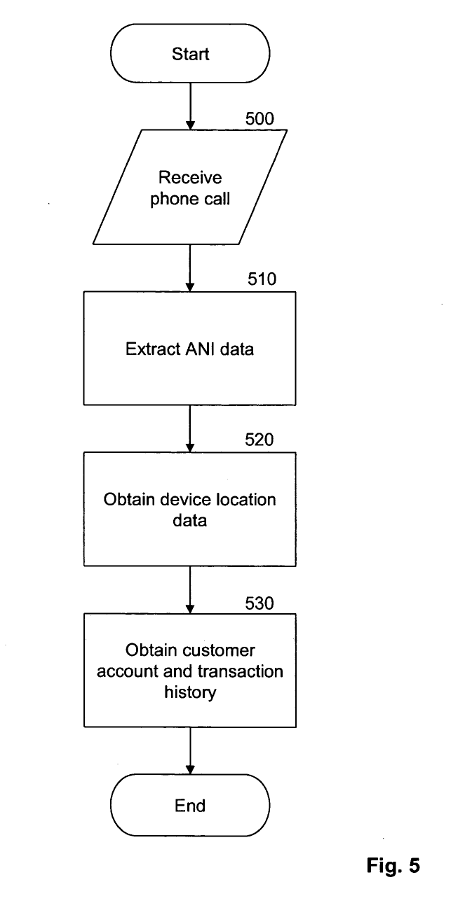

Customer wireless communications are received by the server 230 from the wireless network 270, in block 500 of FIG. 5. The server 230 in some embodiments may extract ANI information from the customer communication data. In other embodiments, the ANI data may be provided separately to the server 230 from a wireless carrier to credit provider access point. Any other type of data that can identify the customer-controlled wireless device may be used, including Internet Protocol (IP) numbers or Media Access Controller (MAC) addresses, such as for wireless communications that connect via a wireless network 270 other than a wireless telephone network. In some embodiments, if the server 230 is unsuccessful in obtaining ANI data or other wireless device 220 identifying data without customer interaction, the server 230 may request wireless device 220 identifying data from the customer, typically via an IVR subsystem of the server 230. In addition, other wireless device 220 identifying data may be obtained. In some embodiments, the wireless network may indicate whether the calling device 220 is in its home area or is “roaming,” as that term is used in the wireless industry to mean outside of the home area. The wireless network 270 may provide GPS data determined by the wireless network 270 to further locate the geographical location of the wireless device 220 when the customer makes the wireless communication. The wireless network 270 also provides the server 230 with wireless network identification and the number called, allowing a single server 230 to handle multiple special phone numbers and multiple wireless networks 270. Other types of wireless device 220 location data may be obtained by the server 230 from the wireless carrier 270 or the sources, including directly from the wireless device 220.

In step 530, the server 230 obtains customer account information, which may include a transaction history for the customer. The server 230 in some embodiments uses the ANI information or other similar wireless device 220 identification data as a lookup key in the database 260 to retrieve the customer account and transaction history data. The customer transaction history may be used when attempting to match the wireless communication with a retail transaction in the matching pool, as described in more detail below.

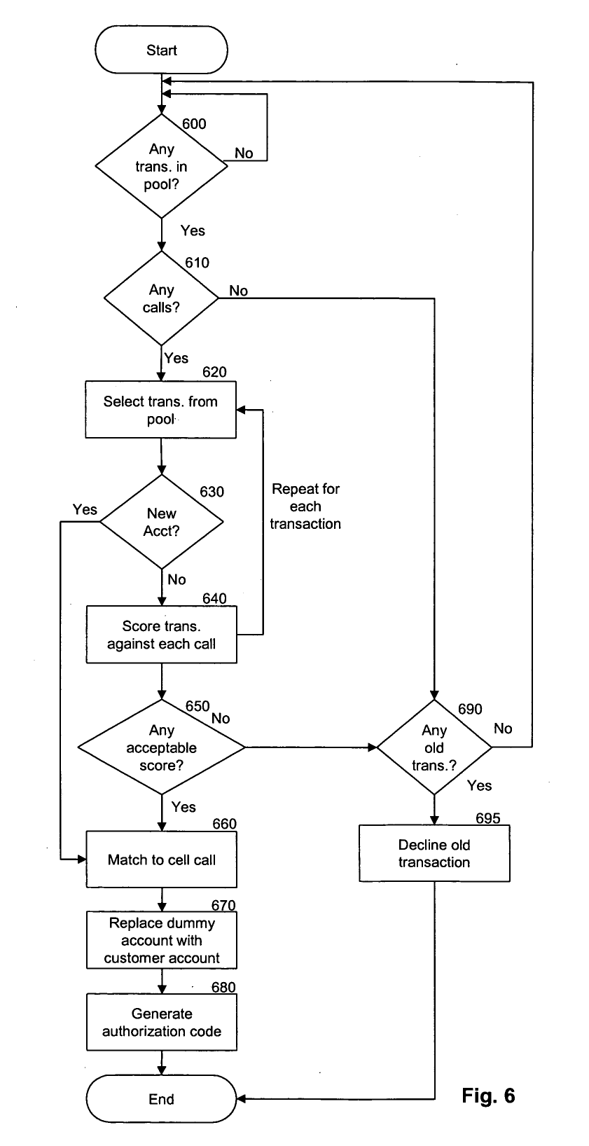

Turning now to FIG. 6, a matching technique is used by the server 230 to match wireless communications with retail transactions. The disclosed technique allows matching the wireless communication with the retail transaction even though wireless communication contains no retail transaction data or customer-controlled identification data and the retail transaction data contains no customer-dependent data.

The matching technique of FIG. 6 is based on deductive reasoning and an understanding of the usage patterns of financial cardholders, particularly private label cardholders. Although the following is described in terms of private label financial cards, the invention is not limited to private label financial cards, and other types of financial cards may be used.

Private label consumers typically display limited usage patterns, because the private label card is limited to a single store or chain of stores. These patterns can then be used in deductive reasoning because of the small number of transactions that make up the set of possibilities.

Statistical analysis of consumer retail transactions suggests that $1,000,000 of sales in one day typically involves 14,000 private label retail transactions. In a typical national 500-store chain, that equates to 28 retail transactions per store per day. In addition, assuming a local retail business day extending from 10:00 A.M. to 9:00 P.M., commonly used for retail stores in shopping malls, there are 50,400 seconds in the four time zones of the U.S. national retail business day, excluding Alaska and Hawaii. In embodiments considering Alaska or Hawaii, the national retail day is correspondingly longer. The disclosed technique further divides the day into a number of processing periods. One disclosed embodiment breaks the day into 10,080 5-second processing periods. Other processing period lengths can be used, with a corresponding number of periods, depending on the period length and length of the retail day. Other shopping days may be used, including data from other countries as desired.

The disclosed embodiments manage how many transactions are likely to be in a “match pool” by a number of factors. For example, not all customers holding the private label card will use wireless communication for performing retail transactions, thus they will be only a subset of the total private label cardholders. In addition, in some embodiments, there may be restrictions on who is offered the ability to make wireless retail transactions. Such a restriction may increase the cachet of the financial card, as well as help manage the size of the “match pool.” In some embodiments, the special phone number used by the customer may be allocated on a by-store basis, with different stores using different special phone numbers. Such an allocation of special phone numbers may be used to split demographically compact highly mobile urban markets, helping limit the size of the match pool.

By controlling access and availability, statistical analysis of consumer retail transactions suggests a distribution of transactions per match period such that most match periods will have only a single transaction, and very few match periods will have more than five transactions. Implementations of the disclosed technique should preferably be able to handle any reasonable number of contemporaneous transactions.

In addition to statistical analysis of transaction frequency, other long-term statistics derived from experience with nationwide private label programs, new account, and fraud-processing programs show certain other characteristic behavior patterns for customers. New accounts on any day typically make up between a small percentage of the private label volume. Almost all new accounts shop in the store at which the customer opened the new account within one hour of opening the account. A majority of private label consumers shop at only one store location with their card. A large majority of private label consumers shop at only two stores. Almost all private label consumers shop within a restricted mileage radius, although the size of the radius varies slightly. Although the above breakdown of 28 transactions per store per day appears to assume an even distribution of transactions across the retail day, the statistics show a disproportionate transaction distribution around three local times: 5 min to noon, 6 P.M., and the store closing time. Any data that provides assistance in matching a retail transaction with a customer account may be used. Thus, transaction size and time of shopping visit may also be used in the matching technique. E.g., if the transaction history of a particular customer shows that she typically shops around 3:00 P.M., and typically spends between $30 and $50, then that information may be used for matching retail transactions with wireless communications, increasing the likelihood that a retail transaction at 3:00 P.M. for $40 was made by that customer, while decreasing the likelihood that a transaction made at 10:00 A.M. for $500 was made by that customer, even though such outlier transactions may eventually be matched with the customer's wireless communications based on other matching criteria.

The match pool consists of one or more retail transactions plus one or more customer account numbers obtained from the database 260 based on the ANI information provided by the wireless network 270. The match pool may contain a subset of the current inbound POS register 210 transactions or customer account numbers from received wireless communications, selecting only transactions that arrived in a given processing period.

Transactions from the POS 210 with the dummy account numbers are routed into the match pool as described above. Retail store phone number data may be accessed for area code information. Time zone and distance from the consumer's home location can be calculated. If there is at least one transaction from the POS 210 and at least one converted wireless communication and a predetermined time has elapsed since the register transaction arrived, then the match pool logic is invoked. In one embodiment, the predetermined time is three seconds. The use of the predetermined elapsed time helps avoid improperly matching transactions with previously received wireless communications related to another transaction.

Turning now to FIG. 6, a flow chart illustrates an embodiment of matching retail transactions and wireless communications. In block 600, if there are no retail transactions in the matching pool, no further actions are performed. Embodiments may check the status of the matching pool during each of the processing periods defined for the retail day or at any other desired interval.

Once a transaction is found by block 600 in the matching pool, in block 610, the server 230 checks to see if any wireless communications are available for matching with the matching pool transactions. If no wireless communications are available for matching, then in block 690, the server examines the matching pool for transactions that have stayed unmatched for a predetermined time, such as 10 or 15 seconds. These “old” transactions may be considered as unmatchable and declined in block 695, using conventional techniques for indicating a declined transaction. Such an old transaction may indicate the customer was unable to or chose not to make the wireless communication. To provide appropriate responsiveness to the retail establishment, a relatively short time limit should be used.

In block 620, the server 230 selects a transaction from the matching pool. If one of the available wireless communications is associated with a recently opened account number as determined in block 630, or if only one transaction and one wireless communication are available for matching, then the server 230 may automatically match that wireless communication with the selected retail transaction in block 660. Otherwise, in block 640, the selected transaction may be scored against each available wireless communication, based on the matching criteria previously described or any other useful matching criteria. In some embodiments, the scoring of block 640 creates a likelihood of match score and a likelihood of mismatch score for each available wireless communication, then creates a differential score of the difference between the match and mismatch scores. In other embodiments, the block 640 may score the transactions using only a likelihood of match or a likelihood of mismatch computation. Other scoring techniques can be used. The server 230 may adjust the scoring of block 630 from time to time, based on statistical analysis of retail transactions and the matching technique's effectiveness at correctly matching retail transactions to wireless communications. In one embodiment, the software code for the match pool processing can be supplied with changeable parameters to allow these or other adjustments. Such an embodiment allows changing parameters based on acceptable response times and the compilation of additional data. Consumer behavior is constantly evolving; therefore, it is contemplated that such adjustments may be appropriate, rather than unexpected.

If any transaction in the matching pool achieves a predetermined score threshold, as determined in block 650 for an available wireless communication, then in step 660, the transaction is matched to the selected wireless communication. In some embodiments, the score must exceed the predetermined score threshold value; in others, the score must be less than the threshold value. In some embodiments, the server 230 may adjust the predetermined threshold values based on statistical analysis of historical data.

Blocks 620 through 640 are typically repeated for each transaction in the matching pool. If multiple transactions meet the score threshold criterion for matching with a single wireless communication, any convenient tie-breaking technique may be used to choose which transaction is matched with the wireless communication.

If any of the transactions in the matching pool do not have an acceptable score as determined in block 650, then those transactions may be reprocessed with the next matching pool in the next processing period. In many cases, there will be only one wireless communication and one retail transaction left for the next pool, or the next pool will produce better matching scores. However, as described above, in block 690 any leftover transactions that are too old may be declined in block 695.

Once a transaction has been matched with a wireless communication, then in block 670 the dummy account data from the POS system 210 may be replaced with the customer account data associated with the wireless device. Although not shown in FIG. 6 for clarity of the drawing, at this stage other conventional credit provider accept/decline authorization techniques may be invoked by the server 230 to complete the authorization of the transaction. If the transaction is acceptable, then in block 680 the server generates an authorization code and sends the authorization information back to the POS 210.

As shown in FIG. 2, the server 230 may create a log file, which may be implemented in any convenient way, for historical data and rematching analysis. The log file may contain the full retail transaction information and the wireless communication data. Other convenient information may be included in the log file in various embodiments. In one such embodiment, additional data about the matching pool is included in the log file, such as the number of transactions in the matching pool for that processing period.

In one embodiment, the authorization code, typically a 6-digit number printed on the receipt in conventional transactions, may be formatted to give information to both the consumer and the retail personnel. For example, the first digit of the authorization code may contain the number of transactions in the match pool. In another example, the last digit may encode the first letter of the last name. One such encoding uses the conventional telephone encoding, e.g., 2 stands for A, B, or C, etc. The above authorization code is illustrative and exemplary only, and other authorization encoding may be used and the use and position of individual digits may be changed. For example, in some embodiments, the authorization code may contain the PIN code previously supplied by the customer with the wireless communication as indicated above. Although the PIN code is not used to match the wireless communication with the retail transaction, the customer may check the authorization code in such an embodiment, informing the retail clerk if the proper PIN code is not present, indicating a possible mismatch. In such embodiments, the position and encoding of the PIN code may vary for PIN code security purposes. Other techniques for using the authorization code to detect a possible mismatch may be used.

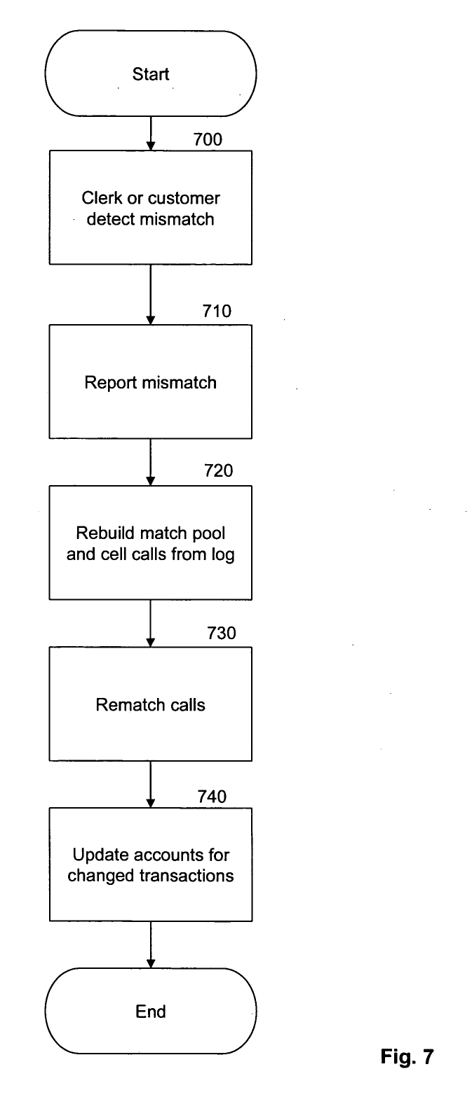

Over an extended period, statistical analysis suggests that the disclosed technique will correctly match the retail transaction to the wireless communication almost all of the time. However, there will be occasional mismatches, for which a rematching technique as illustrated in FIG. 7 may be provided. In one embodiment, the customer agreement associated with the financial card may specify that mismatching can occur, but that customers will pay based on the signature on the sales slip. In block 700, the customer or the retail clerk may detect a mismatch. A retail clerk, in some embodiments using an authorization code as described above, can look at the first digit of the authorization code. If the first digit is a 1, then the clerk need not look further. If the first digit is a 2 or greater, then the retail clerk may compare the first letter of the customer name in the signature with the last number in the authorization code. If the clerk detects a difference, the clerk may call a special phone number, supply the authorization code and the first five letters of the customer name using the telephone button letter to digit translation or any other convenient technique. In some embodiments, these error correction calls may be made by the retailer at the end of the business day or later, instead of at the time of the transaction. In a customer reporting embodiment, the customer may type in the authorization code. Other reporting techniques may be used. Customers may be encouraged to check their transaction online using a website or other conventional techniques for providing online transaction information to customers and may be given instructions and even incentives to use the authorization code described above to help in customer management of their accounts. Likewise, retail personnel may be provided incentives to detect and process authorization code mismatches.

When a customer or retail personnel report an error, the server 230 can re-run the “match pool” logic, using the log data database 270 to rebuild the original matching pool in block 720 from the log file 270, then rematching transactions and wireless communications in block 730, using the technique of FIG. 6. This will enable two transactions to be corrected, in the case of a simple transposition. If more than two transactions were in the match pool, then multiple corrections may be made. In some embodiments, this error correction may consider the date of the transaction and the number of days that have elapsed since the transaction. Any changed transaction can then cause the server 730 to update the associated customer accounts in block 740.

Although described above in terms of a transaction at a physical retail establishment, the disclosed techniques may be used for telephone or online transactions. In such an embodiment, instead of a display of the special phone number at a physical register, the telephone operator or online transaction process would provide the special phone number to the customer, such as in a message indicating, for example, wireless customers should now dial *717 to complete the transaction. In such an embodiment, the matching pool logic would typically not use the customer's physical location as a matching criteria.

The illustrated blocks of the figures are illustrative and exemplary and other blocks and arrangements of blocks may be used. The foregoing disclosure and description of the invention are illustrative and explanatory thereof, and various changes in the details of the illustrated system and techniques and the method of operation may be made without departing from the spirit of the invention.

1. A method of performing a retail transaction, comprising:
initiating a customer-independent transaction detail communication from a retail system to a transaction authorization system;
initiating a customer wireless communication from a customer-controlled wireless communication device to the transaction authorization system;
matching the customer wireless communication with the transaction detail communication; and
identifying a customer account associated with the customer wireless communication; and
authorizing the retail transaction to the retail system.

2. The method of claim 1, further comprising:
supplying a customer-independent token to the retail system.

3. The method of claim 2,
wherein the customer-independent token supplies a customer-independent account data.

4. The method of claim 2,
wherein the customer-independent token supplies a retailer-dependent account data.

5. The method of claim 2,
wherein the customer-independent token supplies a location-dependent account data.

6. The method of claim 2, wherein the transaction detail communication is otherwise identical to a standardized transaction detail communication.

7. The method of claim 1, initiating a transaction detail communication comprising:
supplying a customer-independent token in lieu of a customer-dependent token used in a non-wireless-enabled private label transaction.

8. The method of claim 1,
wherein the retail system is a POS system, and
wherein the POS system can perform the wireless-enabled private label transaction without modification.

9. The method of claim 1, wherein the customer-controlled wireless communication device is a wireless telephone.

10. The method of claim 1, wherein the customer account is a private label credit account.

11. The method of claim 1, authorizing the retail transaction comprising:
modifying the retail transaction to reference the customer account.

12. A method of performing a retail transaction, comprising:
identifying the retail transaction as a wireless-enabled transaction;
initiating a customer-independent transaction detail communication from a retail system to a transaction authorization server;
initiating a customer wireless communication from a customer-controlled wireless communication device to the transaction authorization server, the customer wireless communication independent of customer-supplied customer identification data;
matching a customer account with the transaction detail communication and the customer wireless communication; and
authorizing the retail transaction for the customer account.

13. The method of claim 12, identifying the retail transaction as a wireless-enabled transaction comprising:
supplying a customer-independent token in lieu of a customer-dependent token to a retail system; and
identifying a customer-independent wireless communication network address for the customer wireless communication.

14. The method of claim 13, wherein the customer-independent wireless communication network address is a phone number associated with a retailer.

15. The method of claim 14, the phone number comprising a wireless carrier-dependent special dialing number.

16. Amethod for using a customer charge account, comprising:
generating a retail transaction data, the retail transaction data independent of customer identification data;
matching the retail transaction data to the customer charge account by a customer-initiated wireless communication, the customer-initiated wireless communication independent of the retail transaction data and independent of customer-supplied customer identification data; and.
authorizing the retail transaction for the customer charge account.

17. The method of claim 16, further comprising:
requesting a customer-supplied identification data; and
authenticating the customer-initiated wireless communication by the customer-supplied identification data.

18. A method of matching a retail transaction with a customer account, comprising:
sending a retail transaction data for the retail transaction to a first transaction authorization server, the retail transaction data independent of customer identification data;
identifying a sender of a customer-initiated wireless communication to a second transaction authorization server;
identifying a customer account data associated with the sender;
matching the customer-initiated wireless communication with the retail transaction data; and
associating the customer account data with the retail transaction data.

19. The method of claim 18, wherein the customer-initiated wireless communication is independent of customer-supplied customer identification data.

20. The method of claim 18, further comprising:
rematching the customer-initiated wireless communication with the retail transaction data upon a request for rematching; and
reassociating the customer account data with the retail transaction data.

21. The method of claim 20, wherein the request for rematching is initiated by the sender after the retail transaction is complete.

22. The method of claim 20, wherein the request for rematching is initiated by the retailer.

23. The method of claim 18, further comprising:
transmitting an authorization code for the retail transaction to a retail system, the authorization code, the authorization code providing a transaction matching data.

24. The method of claim 23, wherein the transaction matching data comprises:
a matching data, corresponding to the number of retail transactions considered for matching with the customer-initiated wireless communication; and
a customer data, corresponding to the sender.

25. The method of claim 18, matching the customer-initiated wireless communication with the retail transaction data comprising:
obtaining a wireless device identification data associated with the customer-initiated wireless communication;
identifying the sender by the wireless device identification data; and
obtaining a transaction history data associated with the sender.

26. The method of claim 25, wherein the wireless device identification data comprises an Automatic Number Identification (ANI) data.

27. The method of claim 25, wherein the wireless device identification data comprises a geographic location data.

28. The method of claim 25, wherein the wireless device identification data comprises a wireless network to credit provider access point data.

29. The method of claim 25, wherein the wireless device identification data comprises a roam or home data.

30. The method of claim 25, further comprising:
adding the retail transaction data to a match pool of retail transactions;
establishing a matching score for each retail transaction in the match pool, scoring matching between each retail transaction in the match pool and the wireless communication;
selecting a matching retail transaction from the match pool based on the matching score.

31. The method of claim 25, wherein the transaction history data comprises a customer account initiation time and date data, further comprising:
if the customer account initiation time and date data indicates the customer account was opened within a predetermined time prior to the wireless communication, matching the retail transaction to the wireless communication.

32. The method of claim 25, further comprising:
rejecting the retail transaction if the retail transaction cannot be matched with the wireless communication.

33. A system for authorizing retail transactions for a retail transaction system, comprising:
means for receiving a retail transaction authorization request from the retail transaction system;
means for receiving a customer-initiated wireless communication from a customer wireless device;
means for matching the retail transaction authorization request with the customer-initiated wireless communication; and
means for authorizing or declining the retail transaction authorization request matched with the customer-initiated wireless communication.

34. The system of claim 33, the means for receiving a retail transaction authorization request comprising:
means for identifying the location of the retail transaction system.

35. The system of claim 34, wherein the means for identifying the location of the retail transaction system comprises a customer independent token.

36. The system of claim 33, the means for receiving a retail transaction authorization request comprising a transaction authorization server.

37. The system of claim 33, the means for receiving a customer-initiated wireless communication comprising a transaction authorization server.

38. The system of claim 33, the means for matching the retail transaction authorization request with the customer-initiated wireless communication comprising:
means for identifying the customer wireless device;
means for associating a customer account with the customer wireless device; and
means for matching the customer account with the retail transaction authorization request.

39. The system of claim 38, the means for associating a customer account with the customer wireless device comprising a database.

40. The system of claim 38, the means for identifying the customer wireless device comprising automatic number identification (ANI) data.

41. The system of claim 38, further comprising:
means for associating a customer transaction history with the customer wireless device.

42. The system of claim 38, the means for associating a customer transaction history with the customer wireless device comprising a database.

43. The system of claim 33, wherein the retail transaction authorization request is independent of customer identification data.

44. The system of claim 33, wherein the wireless communication is independent of customer-provided data.

45. The system of claim 33, further comprising:
means for rematching the retail transaction authorization request with the customer-initiated wireless communication upon request.
